(19) United States
(12) Patent Application Publication
(10) Pub. No.: US 2020/0410520 A1
(43) Pub. Date: Dec. 31, 2020

(54) TRANSFERRING DIGITAL CURRENCY AND LOYALTY POINTS VIA MEDIA TO AN EXISTING PAYMENT PORTAL

(71) Applicant: ACTV8, Inc., Beverly Hills, CA (US)

(72) Inventor: Brian Shuster, Beverly Hills, CA (US)

(21) Appl. No.: 16/911,220

(22) Filed: Jun. 24, 2020

Related U.S. Application Data
(60) Provisional application No. 62/867,152, filed on Jun. 26, 2019.

(51) Int. Cl. G06Q 30/02; G06Q 20/36; G06F 9/54; G06F 16/23; G06F 3/0481; G06T 11/00; H04L 29/06

(52) U.S. Cl. CPC G06Q 30/0215; G06Q 30/0239; G06Q 30/0257; G06Q 20/36; G06Q 30/0255; H04L 67/42; G06Q 30/0226; G06F 9/547; G06F 16/2379; G06F 3/0481; G06T 11/00; G06Q 30/0224

(57) ABSTRACT

A system and method to enable digital offers to be saved to a portal selected by a user independent of a source of a digital offer. A device application enables an end user device to receive digital offers, from a broadcast service, a streaming media service, a media trigger, a geofence trigger or a Bluetooth® beacon trigger. An API client retrieves a device ID from the user device and communicates with a backend server to create or update a device record. The device application requests and receives a video ad with a media ID from an ad server, or receives a trigger with a trigger ID. The API client using the media ID or trigger ID requests from the backend server a digital offer corresponding to said media or trigger ID. The user is able to select a desired portal or digital wallet to save the digital offer.

### FIELD OF THE INVENTION

The invention is directed to the field of digital wallets and equivalents and provides a mechanism to add coupons or other incentives received on a mobile or other device to a user selected digital wallet or equivalent.

### BACKGROUND OF THE INVENTION

The invention relates to how audio, video and static advertisements can be layered with digital currency and reward points and then saved into pre-existing payment portals or loyalty portals sometimes referred to as digital wallets.

The digital currency and rewards points can be “sent or trigged from audio, video, static images, location, metadata tags, streaming video, and audio tags. The source of those tags or triggers could include but are not limited to set-top boxes, smart T.V.s, web sites, audio, video, static images, location, metadata tags, streaming video, audio tags, and phones. The invention provides the ability to trigger those rewards points or digital currency from new mediums and then save those transferred currencies or points into an existing loyalty portal or payment portal which is selected by the user. In the prior art, the user is not able to dynamically direct such rewards points or digital currency to a loyalty portal or payment portal selected by the user.

### SUMMARY OF THE INVENTION

In one embodiment, after a consumer's device, such as a mobile phone or tablet, recognizes a trigger, a digital offer connected to the content being viewed, heard, or seen, the consumer can then save that offer to a preferred financial institution or credit card or loyalty card issuer. This means that after a consumer views, hears, or sees a video, audio, or static ad, the invention enables them to save reward points and/or digital currency from the advertisement to their financial institution credit card or loyalty rewards program of choice. The invention rewards consumers for watching or listening to content and then enables those consumers to save those rewards directly into existing payment portals or loyalty portals.

In another embodiment, the digital currency and rewards points are associated with an ad which is displayed while the user is watching or listening to media content. Thus, no specific trigger is needed. After the ad is played, the digital offer connected to the content being viewed, heard, or seen, can be saved to the user's preferred financial institution or credit card or loyalty card issuer. This means that after a consumer views, hears, or sees a video, audio, or static ad, the invention enables them to save reward points and/or digital currency from the advertisement to their financial institution credit card or loyalty rewards program app of choice. The invention rewards consumers for watching or listening to content and then enables those consumers to save those rewards directly into existing payment portals or loyalty portals.

This new invention enables content makers and media companies to transfer digital currency and loyalty points via media to an existing payment portal. The existing payment portal could be a credit card portal, merchant portal, travel portal, or any portal that works with payment or loyalty points.

This new invention dynamically adds a transactional layer onto any media content, including television content, movie content, advertisements, and any audio content. This transactional layer enables the transfer of the digital currency to a portal selected by the user.

### BRIEF DESCRIPTION OF THE DRAWINGS

FIG. 1 is a diagram showing how the invented method and system allows users to save currency/points/rewards from a TV or radio to a native mobile wallet for later use.

FIG. 2 is a diagram showing how the invented method and system allows users to save currency/points/rewards triggered via geofencing and/or Bluetooth® beacons.

FIG. 3 is a diagram showing the workflow related to a system which allows users to save currency or loyalty points to a digital wallet.

FIG. 4 is a diagram showing the workflow related to a system which allows users to save currency or loyalty points to an existing payment or loyalty portal from a broadcast source.

FIG. 5 is a diagram showing the workflow related to a system which allows users to save currency or loyalty points to an existing payment or loyalty portal from a digital streaming source which includes a trigger mechanism.

### DETAILED DESCRIPTION OF THE INVENTION

As a preliminary matter, it will readily be understood by one having ordinary skill in the relevant art that the present disclosure has broad utility and application. Therefore, any embodiment may incorporate only one or a plurality of the disclosed aspects of the disclosure and may further incorporate only one or a plurality of the disclosed features. Furthermore, any embodiment discussed and identified as being “preferred” is considered to be a particular mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claims rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

A method and system are disclosed that allows advertisers, content creators, and content distributors to issue rewards or loyalty points from any media source. It then provides the ability for the consumer to instantly transfer that digital currency/rewards points from the media or content into their respective media wallet and apply towards purchase.

The invented process starts from an end-user device where a client application is installed. Either manually (by the end-user) or automatically (by an internal process), the client application is launched, and an API client is loaded. The API client retrieves a unique device identifier from the operating system and sends a request to a backend server to create a new device instance or update an existing one.

Using device interfaces such as a microphone, GPS, Bluetooth®, and an Internet connection, the device is capable of detecting signals from audio, media, geofences, and Bluetooth® beacons. The client application can decode a unique identifier embedded within the detected signals and use it to request currency/loyalty points through the API client.

The backend server processes the request and delivers the corresponding currency/loyalty points. The API client parses the server response into a format compatible with the client application. The client application renders the server response into a user-friendly interface that displays the currency/loyalty points details. The user interface lets the user save the currency/loyalty points into the digital wallet of his/her preference.

Upon user selection, the client application sends a request to the backend server to save the currency/loyalty points. The backend server establishes a secure connection based on a rewards server protocol requirements and makes a request to add to the user's currency/loyalty rewards program. The user then accesses his/her rewards program via a digital wallet application from which he/she can redeem collected currency/loyalty points.

The method and system provide a mechanism for allowing, T.V. ads/programming, radio, Bluetooth® beacons, augmented reality, geo-fencing, set-top box, smart T.V., web, or phones, to distribute “digital currency” or rewards points, allowing consumers to receive monetizable value on their mobile device in real-time or time-shifted. The offers can then be saved into a financial institution wallet of choice.

For example, a consumer watches a T.V. advertisement via a T.V. After opting-in, the consumer would receive targeted offers from the content. In an embodiment, the mobile device prompts the user with a button for currency/points/rewards to be saved into a digital wallet of a preferred financial application. Once a consumer receives a pre-determined amount of digital currency, the consumer can apply it towards a purchase at any retailer that accepts digital currency from such digital wallet.

More specifically, when a viewer is watching content on a device and an advertisement comes on, the content audio includes an audio signal which when detected by the mobile device enables the transfer of digital currency/points to the viewer's mobile device. Consumers can then save points and/or currency provided by the content they are watching directly into an existing digital wallet payment portal such as a credit card or loyalty program app.

These transactional ads enable any media to distribute currency/awards points to any mobile device and allows the consumer to save that currency/loyalty points triggered by the media into an existing credit card payment or loyalty program digital wallet.

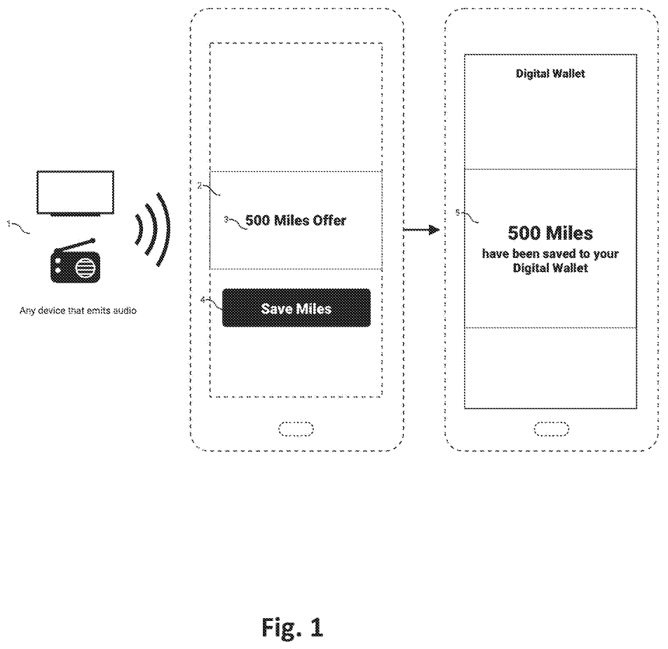

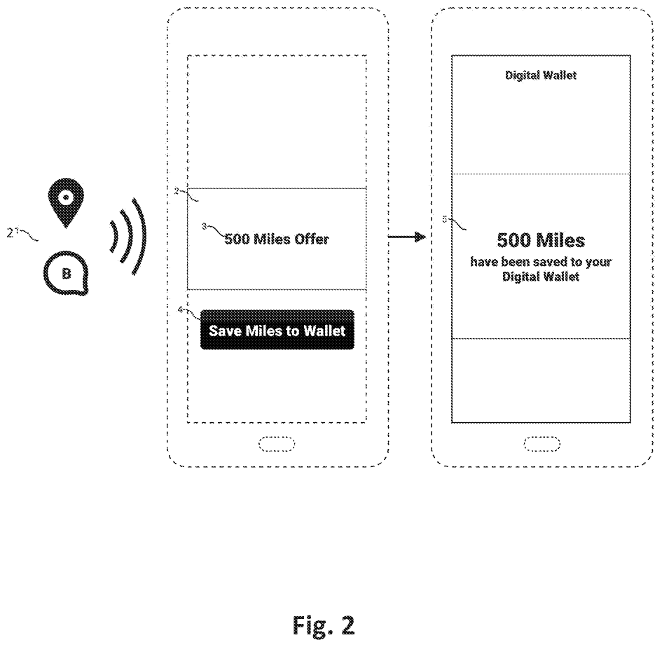

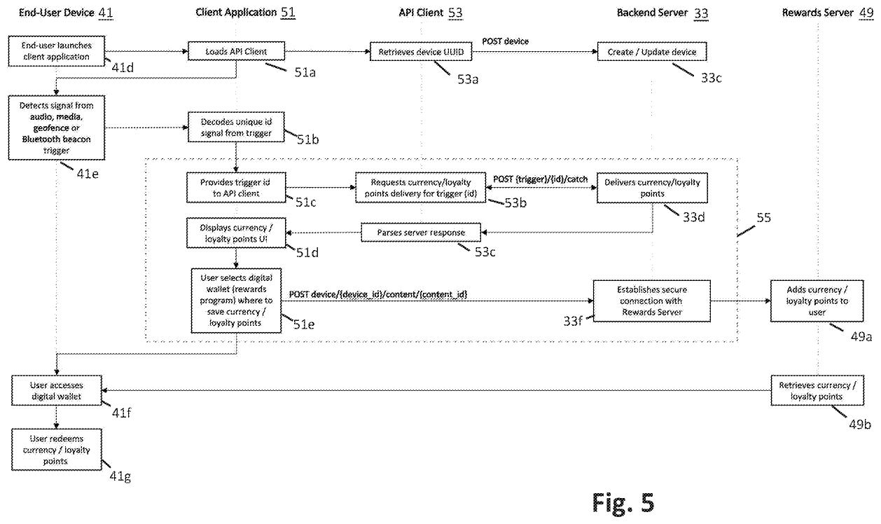

FIG. 1 is a diagram showing how the invented method and system allows users to save currency/points/rewards from a TV or radio to a native mobile wallet for later use. Although a TV or radio is shown, the same technique works with Bluetooth® beacons, augmented reality devices, geo-fencing, web sites, or phone, tablet or other computing device as will be explained with reference to FIGS. 2 and 5.

An advertisement is broadcast on a TV or radio 1, or an any other audio-emitting device. As one example, such advertisement could be a clothing store TV ad. The advertisement is recognized by a mobile device 2 using recognition software such as audio watermarks or audio fingerprints. The specifics of creating and recognizing audio watermarks or audio fingerprints are well known in the art, and, therefore, such specifics are not further described herein.

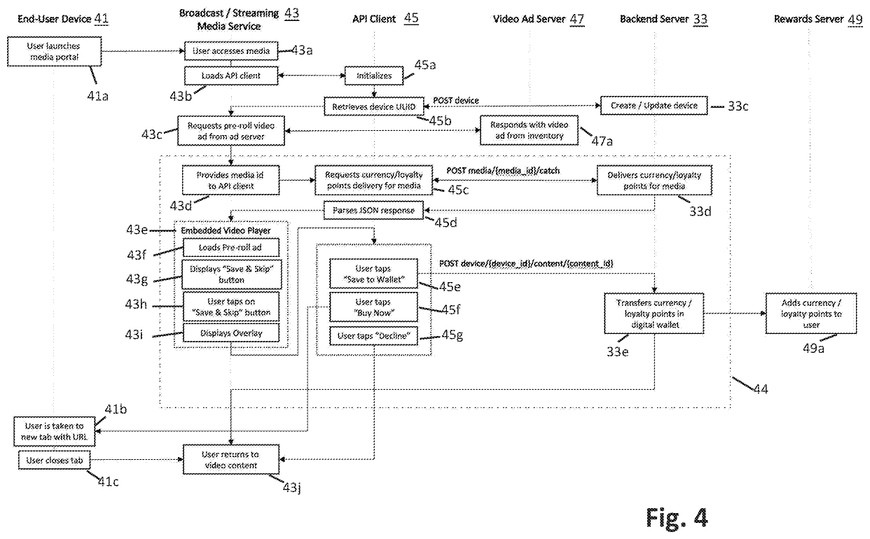

Associated with that audio watermark or fingerprint is an offer 3 having an assigned value of digital currency, such as airlines mileage. Of course the digital currency can be points for any kind of loyalty program or a cash credit. The specifics regarding how such association is made will be described with reference to FIG. 4.

The digital currency that was recognized/identified (via the mobile device) can be stored 4 on the mobile device in a digital wallet selected by the user.

After the digital currency is stored on the mobile device, it is automatically loaded into a preferred credit card issuer or loyalty card program 5.

When the user desires to use the digital currency that was identified and saved on the mobile device, and assigned to a preferred credit card issuer or loyalty card, the digital currency can be used towards payment of products from that card issuer.

Of course, the advertisement could be for any product or service, and the saved digital currency stored in a digital wallet associated with that product or service. The invention is the mechanism for detecting and saving the offer to a specific user selected digital wallet or equivalent.

FIG. 2 illustrates an embodiment where instead of an audio signal, the offer is triggered via geofencing and/or Bluetooth® beacons. A specific location 21 has been identified on a map or has a Bluetooth® beacon strategically placed. That location is assigned a digital ID tag. The location ID is recognized by mobile device 2 using GPS recognition software and/or Bluetooth® beacon detection, both of which are well known in the art and need not be further described herein.

Associated with that location is an ID tag that has an assigned value of “digital currency” 3. As shown on FIG. 2, the assigned value is 500 airline miles. The “digital currency” that was recognized/identified (via the mobile device) can be stored 4 on the mobile device 2.

After the “digital currency” is stored on the mobile device, it is automatically saved into a preferred credit card issuer or loyalty card/program using a digital wallet 5. When the user shops at a merchant's store which accepts the digital currency that was identified and saved on the mobile device (and assigned to a preferred credit card issuer or loyalty card), that digital currency can be used towards payment of the merchant's products. The specifics regarding using a digital wallet to save digital currency and then use the digital wallet to make purchases are well known in the art.

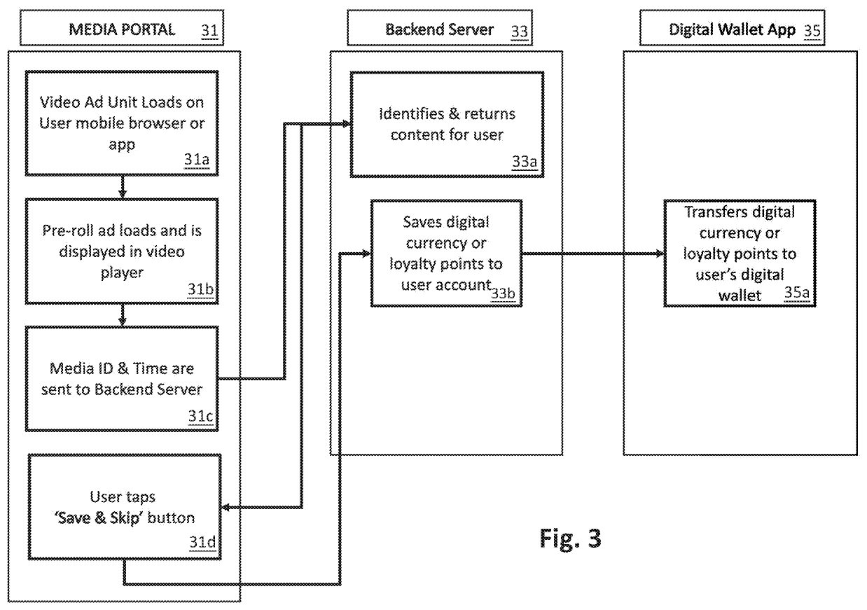

FIG. 3 is a diagram showing the workflow related to a system according to the invention which allows users to save currency or loyalty points to a digital wallet.

FIG. 3 shows a media portal 31 which is in the nature of an app running on mobile device 2, a backend server 33 and a digital wallet app 35 which is also an app running on mobile device 2.

Mobile device 2 detects audio or other source trigger as noted above with reference to FIGS. 1 and 2. Such source triggers include audio from a TV or radio which has been fingerprinted with an audio watermark as is well known in the art. The trigger could be a Bluetooth® signal or a GPS signal which is detected when the mobile device is near the source of the signal, or, in the case of a GPS signal, within a defined radius of specified location. For example, while shopping in a department store, the user approaches a display with items on sale. A Bluetooth® signal is received by the user's mobile device as the user approaches the display. As the user is watching or listening to media content via media portal 31, a video ad unit 31a is loaded on the device 2 using either a mobile browser or app. As the media content is played, an ad loads and is displayed 31b with a video player which is used to provide the media content. The ad has associated with it a media ID and time which is sent 31c to backend server 33.

The backend server identifies and analyzes the received information and returns 33a the offer/digital currency to the mobile device which then displays a Save & Skip button or equivalent button for the user to tap 31d for storage in its digital wallet. By taping the button, the backend server is notified and it saves 33b the digital currency to the user's account and via the device's digital wallet app, it transfers 35a the digital currency to the user's digital wallet on device 2. Further details regarding this process are described in conjunction with FIG. 4.

FIG. 4 is a diagram showing the workflow related to a system allowing users to save currency or loyalty points to an existing payment or loyalty portal from a broadcast source.

Shown in FIG. 4 are end user device 41 which is typically a mobile phone such as mobile phone 2 shown in FIG. 1, broadcast/streaming media service 43 and API client 45 which run on end user device 41, video ad server 47, backend server 33 and rewards server 49.

The user launches 41a a media portal 31 (see FIG. 3) on device 41. Once the media portal has been launched, the user is able to access media 43a and API client 45 is loaded 43b. API client 45 initializes 45a and retrieves 45b the end user device UUID, then backend server creates or updates 33c a record for the device. The API client 45 causes media service 43 to request 43c an ad from video ad server 47 which responds 47a with an ad from its inventory. At this point broadcast and digital streaming source core components 44 begins operating.

Media service 43 provides 43d a media ID corresponding to the ad provided by the ad server to API client 45. API client 45 requests 45c the digital currency/loyalty points associated with the ad to backend server 33. Backend server 33 then delivers 33d the so obtained digital currency/loyalty points to API client 45 which parses 45d the data from backend server 33 and sends it to an video player 43e embedded in device 41.

The video player operates to load 43f the ad and play it. As the ad is playing, or when the ad is completed, the user is presented with a save and skip button 43f or equivalent. The user taps 43h the button and is then presented with a displayed overlay 43i which causes API client 45 to display three options: “Save to Wallet” 45e, “Buy Now” 45f and “Decline” 45g. Of course, the precise wording displayed can be set as needed.

If the user taps the “Save to Wallet” button 45e, the API client contacts backend server 33 with the relevant offer information and backend server transfers 33e the digital currency so that the rewards server 49 associates 49a the digital currency with the user.

The user is then returned to 43j the content which being watched before the ad began playing.

If the user taps the “Buy Now” button 45f, end user device 41 then opens 41b a browser page from which the product or service which was advertised may be purchased. After the transaction is complete 41c, the user is returned 43j to the content being played before the ad began.

If the user taps the “Decline” button 45g, the user is then returned 43j to the content which was being watched before the ad began playing.

As noted above, the system also operates via a trigger. FIG. 5 is a diagram showing the workflow related to a system allowing users to save currency or loyalty points to an existing payment or loyalty portal from a digital streaming source which includes a trigger mechanism.

Shown in FIG. 5 are end user device 41 which is typically a mobile phone such as mobile phone 2 shown in FIG. 1, client application 5l and API client 53 which run on end user device 41, backend server 33 and rewards server 49.

After the end user launches 41d the client application 51, API client 53 is loaded 51a. API client 53 retrieves 53a the end user device UUID, then backend server creates or updates 33c a record for the device.

End user device 41 then can detect 41 a trigger from audio or video media, a geofence or Bluetooth® beacon as described above with reference to FIG. 2. The trigger contains a unique ID which is decoded 51b by client application 51. At this point audio or video media, geofence or Bluetooth® trigger core components 55 begins operating.

The trigger ID is then provided 51c to API client 53 which requests 53b the associated digital currency/loyalty points from backend server 33. Backend server 33 delivers 33d the associated digital currency/loyalty points to API client 53 which parses 53c the data provided by backend server 33 and sends it to client application 51 which displays 51b the obtained digital currency/loyalty points to the user.

The client application 51 then allows the user to select 51e the specific digital wallet to save the digital currency/loyalty points. The client application 51 then communicates with backend server 33 which establishes 33f a connection with rewards server 49. Rewards server 49 then adds 49a the digital currency/loyalty points to an account previously established by the user.

In this manner, at some later point in time, the user using the end user device accesses 41f the digital wallet in which the digital currency/loyalty points were stored, and retrieves 49b them from rewards server 49 for redemption 41g.

Generally, consistent with embodiments of the disclosure, aspects of the invention may be implemented as program modules which include routines, programs, components, data structures, and other types of structures that may perform particular tasks or that may implement particular abstract data types. Moreover, embodiments of the disclosure may be practiced with various computer system configurations, including computer servers, hand-held devices, general purpose graphics processor-based systems, multiprocessor systems, microprocessor-based or programmable consumer electronics, application specific integrated circuit-based electronics, minicomputers, desktop, laptop, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, or device. The computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory such as RAM or ROM and other storage mediums, data can also be stored on or read from other types of computer-readable media, such as secondary storage devices, like hard disks, solid state storage (e.g., USB drive), or a CD-ROM, a carrier wave from the Internet. Further, the disclosed method stages may be modified in any manner, including by reordering stages and/or inserting or deleting stages, without departing from the disclosure. Although the invention has been explained in relation to its preferred embodiment, it is to be understood that many other possible modifications and variations can be made without departing from the spirit and scope of the invention as defined by the following claims.

I claim:

1. A system to enable digital offers to be saved to a portal selected by a user independent of a source of a digital offer comprising:
a device application for enabling an end user device to receive digital offers, said device application including at least one of a broadcast service and a streaming media service for receiving media content, wherein
said device application upon being launched on the end user device loads an API client;
said API client retrieving a device ID from said device and communicating with a backend server for creating or updating a device record on said backend server;
said device application requesting and receiving a video or audio ad with a media ID from an ad server;
said API client using said media ID requests from said backend server a digital offer corresponding to said media ID and providing to said end user device application data corresponding to said digital offer for use by a portal selected by a user;
said device application including a video or audio player which loads and plays said ad, and displays a user selection button;
upon said user selection button being selected by said user, said video or audio player displays as an overlay which presents a save to wallet, a buy now and a decline options;
if said user selects said save to wallet option, said API client communicates with said backend server to save the digital offer to said user selected portal, said backup server for transferring said digital offer and associated user information to a corresponding rewards server for subsequent access by said user using said user selected portal.

2. The system defined by claim 1 wherein if said user selects said buy now option, said API client causes said device to display information to enable said user to enter into a buy transaction.

3. The system defined by claim 1 wherein if said user selects said decline option, said API client causes said device application to return to play video or audio content provided by said broadcast service or said streaming media service.

4. The system defined by claim 1 wherein after said API client communicates with said backend server, said API client causes said device application to return to play video or audio content provided by said broadcast service or said streaming media service.

5. The system defined by claim 1 wherein said user selected portal is a digital wallet.

6. A system to enable digital offers to be saved to a portal selected by a user independent of a source of a digital offer comprising:
a backend server for communicating with an API client on an end user device and a rewards server;
said backend server receiving from said API client an end user device ID and creating or updating a device record corresponding to said end user device ID;
said backend server using a media ID corresponding to an ad sent to said end user device sending said API client a digital offer corresponding to said media ID, said API client providing to said end user device application data corresponding to said digital offer for use by a portal selected by a user;
said end user device having a device application including a video or audio player which loads and plays said ad, and displays a user selection button;
upon said user selection button being selected by said user, said video or audio player displays as an overlay which presents a save to wallet, a buy now and decline options;
if said user selects said save to wallet option, said backend server communicates with said API client to save the digital offer to said user selected portal, said backup server transferring said digital offer and associated user information to said rewards server for subsequent access by said user using said portal.

7. A method to enable digital offers to be saved to a portal selected by a user independent of a source of a digital offer comprising:
enabling an end user device to receive digital offers from least one of a broadcast service and a streaming media service;
loading an API client on said end user device;
said API client retrieving a device ID from said device and communicating with a backend server for creating or updating a device record on said backend server;
receiving a video or audio ad with a media ID from an ad server;
said API client using said media ID requesting from said backend server a digital offer corresponding to said media ID and providing to said end user device application data corresponding to said digital offer for use by a portal selected by a user;
loading and playing said ad;
displaying a user selection button;
upon said user selection button being selected by said user, displaying as an overlay a save to wallet, a buy now and a decline options;
if said user selects said save to wallet option, said API client communicating with said backend server to save the digital offer to said user selected portal, said backup server for transferring said digital offer and associated user information to a corresponding rewards server for subsequent access by said user using said user selected portal.

8. The method defined by claim 7 wherein if said user selects said buy now option, said API client causing said device to display information to enable said user to enter into a buy transaction.

9. The method defined by claim 7 wherein if said user selects said decline option, said API client causing said device application to return to play video or audio content provided by said broadcast service or said streaming media service.

10. The method defined by claim 7 wherein after said API client communicates with said backend server, said API client causing said device application to return to play video or audio content provided by said broadcast service or said streaming media service.

11. The method defined by claim 7 wherein said user selected portal is a digital wallet.

12. A system to enable digital offers to be saved to a portal selected by a user independent of a source of a digital offer comprising:
a device application for enabling an end user device to receive digital offers based on a trigger from one of a signal embedded in media content, a geofence and a Bluetooth® beacon wherein
said device application upon being launched on the end user device loads an API client;
said API client retrieving a device ID from said device and communicating with a backend server for creating or updating a device record on said backend server;
said device application receiving said trigger signal and decoding a trigger ID using said trigger signal;
said API client using said trigger ID requests from said backend server a digital offer corresponding to said trigger ID and providing to said end user device application data corresponding to said digital offer for use by a portal selected by a user;
said device application displaying said digital offer for saving to a user selected portal;
upon said user selecting a portal, said device application communicates with said backend server to add said digital offer to a rewards server for subsequent access by said end user device via said user selected portal.

13. The system defined by claim 12 wherein said end user device communicates with said rewards server via said user selected portal to enable said user to redeem said digital offer.

14. The system defined by claim 12 wherein said portal is a digital wallet.

15. A method to enable digital offers to be saved to a portal selected by a user independent of a source of a digital offer comprising:
enabling an end user device to receive digital offers based on a trigger from one of a signal embedded in media content, a geofence and a Bluetooth® beacon wherein
loading an API client;
said API client retrieving a device ID from said device and communicating with a backend server for creating or updating a device record on said backend server;
receiving said trigger signal and decoding a trigger ID using said trigger signal;
said API client using said trigger ID requests from said backend server a digital offer corresponding to said trigger ID and providing data corresponding to said digital offer for use by a portal selected by a user;
displaying said digital offer for saving to a user selected portal;
upon said user selecting a portal, communicated with said backend server to add said digital offer to a rewards server for subsequent access by said end user device via said user selected portal.

16. The method defined by claim 15 wherein said end user device communicating with said rewards server via said user selected portal enables said user to redeem said digital offer.

17. The method defined by claim 15 wherein said portal is a digital wallet.

18. A system to enable digital offers to be saved to a portal selected by a user independent of a source of a digital offer comprising:
a backend server for communicating with an API client on an end user device and a rewards server;
said backend server receiving from said API client an end user device ID and creating or updating a device record corresponding to said end user device ID;
said backend server using a trigger ID corresponding to a trigger sent to said end user device sending said API client a digital offer corresponding to said trigger ID, said API client providing to said end user device application data corresponding to said digital offer for use by a portal selected by a user;
if said user selects said save to wallet option, said backend server communicates with said API client to save the digital offer to said user selected portal, said backup server transferring said digital offer and associated user information to said rewards server for subsequent access by said user using said user selected portal.

19. The system defined by claim 1 wherein said digital offer is one of digital currency and loyalty points.

20. The system defined by claim 5 wherein said digital offer is one of digital currency and loyalty points.

21. The method defined by claim 7 wherein said digital offer is one of digital currency and loyalty points.

22. The system defined by claim 12 wherein said digital offer is one of digital currency and loyalty points.

23. The method defined by claim 15 wherein said digital offer is one of digital currency and loyalty points.

25. The system defined by claim 18 wherein said digital offer is one of digital currency and loyalty points.
